(19) United States
(12) Patent Application Publication
(10) Pub. No.: US 2024/0005452 A1
(43) Pub. Date: Jan. 4, 2024

(54) CAMERA ROTATION FOR MULTI-POSTURE COMPUTING DEVICES

(71) Applicant: MICROSOFT TECHNOLOGY LICENSING, LLC, Redmond, WA (US)

(72) Inventors: Michael Jeffrey AJAX, Redmond, WA (US); Naveen THUMPUDI, Redmond, WA (US); Gerrit Lance SWANEVELD, Kenmore, WA (US); Sang Kun CHOE, Redmond, WA (US)

(21) Appl. No.: 17/853,700

(22) Filed: Jun. 29, 2022

(51) Int. Cl. G06T 3/60; G06T 7/10

(52) U.S. Cl. CPC G06T 3/60; G06T 7/10; G06T 2207/20132; G06T 2207/10016

(57) ABSTRACT

The techniques disclosed herein enable systems to perform automatic camera rotation for multi-posture devices (e.g., tablet devices, foldable devices, external displays with built-in webcams) irrespective of a current posture of the computing device. This is accomplished by reformatting an image captured by an image sensor using an image signal processer prior to encoding for output. To reformat the image, the computing device determines an angle of rotation for the computing device relative to a default posture. The image is then rotated based on the angle of rotation such that the image appears right side up for the current posture. Subsequently, the image is cropped from its original aspect ratio to a predetermined aspect ratio. Finally, the image is encoded to generate an output stream that can be received by an application. In this way, the system maintains visual consistency even as a user rotates the device.

### BACKGROUND

In recent years, communication applications and platforms have experienced significant proliferation as more users utilize text and video features to communicate for professional and personal purposes. As remote work grows in popularity, individual users and large organizations alike demand smooth experiences to maintain efficiency and facilitate effective communication. To improve the flexibility of their applications, many communication platforms have expanded compatibility to include a wide variety of device types. For example, most major applications support desktop devices, smartphone devices, laptop devices, tablet devices, and foldable devices.

An important feature of these communications platforms is video calling which enables users of various device types to see and speak to each other. For example, a user of a desktop device places a camera on their desk and broadcasts a video stream to a communication session. However, interacting with communication platforms using other device types may involve different camera placements and setups. For instance, a user of a tablet device may use either a front-facing or rear-facing camera in a video call. In addition, the user may hold the tablet in different postures, such as a horizontal “landscape” posture or a vertical “portrait” posture. Because the cameras of the tablet device are typically fixed to the device, the application must consider how these postures affect the output of an image. In addition, camera placement is not identical across all models of tablet devices, smartphone devices, foldable devices, and so forth.

For example, while the user holds a tablet device in a first posture (e.g., landscape posture), the user's image appears in a video call right side up. However, if the user rotates the tablet device ninety degrees to another posture (e.g., portrait posture), the communication application must detect the changed posture and rotate the user's image accordingly. Otherwise, the user may appear upside down, sideways, or in any number of unwanted positions. Naturally, inconsistencies in the video call experience can oftentimes lead to frustration, decreased productivity, and other detrimental factors that can cause a user to stop using the communication platform, or the computing device altogether.

### SUMMARY

The techniques described herein provide systems for enhancing the functionality of multi-posture computing devices by introducing automatic rotation and/or cropping of camera images to maintain a consistent output stream irrespective of the posture of an associated computing device (e.g., a tablet device, a foldable device, an external display with a built-in webcam). This is accomplished by reformatting an input image received from an image sensor prior to outputting the image to an application for display and/or transmission. In various examples, reformatting the image involves rotating the image based on a current rotation of the computing device from a default posture and/or cropping the image to a predetermined output resolution and/or aspect ratio. Furthermore, image reformatting can be performed using a variety of methods. In one example, an image signal processor (ISP) is configured to reformat images and generate an output stream. In an alternative example, a camera module is configured with a software driver to enable the camera module to reformat images.

The techniques discussed herein are implemented in association with any computing device that includes a “fixed” camera. A camera is fixed if the image sensor rotates when the computing device rotates. Moreover, for the sake of discussion, a “posture” includes any physical orientation (e.g., a horizontal orientation or a vertical orientation) that can be measured by a position sensor to inform a fixed camera on image reformatting. In addition, a “posture” includes any software defined orientations that can cause a change in the user interface of the computing device such as screen auto-rotate and/or rotation lock.

In this way, the disclosed system addresses several technical challenges associated with image processing for video capture (e.g., video calling, video recording, livestreaming) in multi-posture computing devices. For instance, typical solutions for video capture on multi-posture devices rely upon individual applications to determine the current posture of the device and rotate the output image accordingly. However, not all applications are designed with every computing form factor in mind. In one example, a desktop device, a tablet device, and a laptop device all utilize the same operating system to enable broad application compatibility. Unfortunately, a communication application for the operating system may have been designed with only desktop devices in mind. Consequently, a user of a tablet device may experience inconsistencies during a video call while holding the tablet device in various postures. Such situations also apply to other handheld devices such as smartphones and foldable devices. As mentioned above, this can lead to a degraded and frustrating user experience.

Moreover, by relying upon applications to produce correct camera behaviors, the applications must also anticipate dynamically changing aspect ratios at runtime. In an illustrative example, a tablet device is equipped with a front-facing camera with a 16:9 aspect ratio that is aligned with the aspect ratio of the display of the tablet device. Stated another way, the camera is mounted on the long edge of the tablet device. When a user is holding the tablet device in a landscape posture, the output image from the camera appears in a communication application as an image with a 16:9 aspect ratio. If the user rotates the tablet device to hold the tablet device in a portrait posture, the tablet device can detect the changed posture and rotate the output image accordingly. However, the output image from the camera suddenly changes to a 9:16 aspect ratio. This further adds to the inconsistency and awkwardness of the user experience in typical video calling solutions.

In contrast, by reformatting the image using the camera ISP, the disclosed system provides a consistent output stream to various applications. That is, the output image remains in a fixed orientation and aspect ratio regardless of the device posture, which can constantly change. As such, the camera can be configured by the operating system to appear, to applications, as an external device despite being integrated into the computing device. Consequently, the disclosed system enables a smooth and consistent user experience in video calls irrespective of device type and/or device posture. Furthermore, the techniques discussed herein remove the burden from individual applications to correctly rotate output images and account for dynamically changing aspect ratios. In this way, the disclosed system improves the efficiency of communications applications by requiring the application to simply display and/or transmit the formatted output stream thereby reducing resource usage.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates an example operating environment of an example system for enabling camera rotation for multi-posture computing devices in a first horizontal posture (e.g., landscape posture).

FIG. 1B illustrates an example operating environment of an example system for enabling camera rotation for multi-posture computing devices in a second horizontal posture (e.g., an alternative landscape posture).

FIG. 2 illustrates an example operating environment of an example system for enabling camera rotation for multi-posture computing devices in a first vertical posture (e.g., portrait posture).

FIG. 3A illustrates a block diagram of an example system for enabling camera rotation for multi-posture devices processing a first example image input.

FIG. 3B illustrates a block diagram of an example system for enabling camera rotation for multi-posture devices processing a second example image input.

FIG. 3C illustrates a block diagram of an example system for enabling camera rotation for multi-posture devices processing a third example image input.

FIG. 4 is a block diagram illustrating additional aspects of an example system for enabling camera rotation for multi-posture devices.

FIG. 5 is an example flow diagram showing aspects of a routine for enabling camera rotation for multi-posture devices.

FIG. 6 is a computer architecture diagram illustrating an example computer hardware and software architecture for a computing system capable of implementing aspects of the techniques and technologies presented herein.

### DETAILED DESCRIPTION

The techniques described herein improve the functionality of multi-posture computing devices in the context of video communications by introducing camera rotation that enables consistent output images regardless of device type and/or device posture. An example of a multi-posture computing device is a tablet device which a user can hold in various postures (e.g., right side up landscape posture, upside down landscape posture, portrait posture). Unlike traditional computing form factors, such as desktop devices and laptop devices which are not typically rotated, multi-posture devices are intended to be rotated to enable a user to comfortably work and/or consume media among other activities. However, this dynamic rotation introduces several peculiarities when the user is utilizing the camera for video calling or other video use scenarios.

For instance, traditional computing devices follow desktop or laptop clamshell form factors. In these form factors, there is no concept of dynamic rotation based on the current posture of the device. Stated another way, a laptop device is intended for use strictly in an upright laptop posture while a desktop device typically has external displays configured in a landscape or portrait format. When a user attaches a camera to one of these form factors, the camera is typically placed such that the camera (e.g., a webcam) is aligned with the upper edge of the display. As such, communication applications are typically designed with this assumption in mind.

As tablet and other multi-posture form factors gain popularity, similar assumptions generally still hold true as users tend to hold tablet devices in a landscape posture for video calling despite having the capability to freely rotate the table devices. Nonetheless, various operating systems for tablet devices provide mechanisms such as application programming interfaces (APIs) that enable support for applications to perform image rotation based on the current posture of the device. This accommodates a situation where a user wishes to participate in a video call while the device is in a portrait posture. As such, the burden of correctly rotating camera images falls to individual communication applications. Unfortunately, implementing camera rotation behavior is inconsistent on a per application basis leading to a frustrating user experience. For instance, the image of a user may be incorrectly rotated when presented in a video call causing the user to appear upside down, sideways, or any number of undesirable positions. This is illustrated in examples provided below.

To deliver a more natural camera experience in multi-posture computing devices, the disclosed system instead places the responsibility for image rotation on components (e.g., an image signal processor (ISP), a driver) of the camera. That is, the ISP or the driver is aided by various operating system modules and/or on-device sensors. The ISP or driver first receives an image from an image sensor that is fixed to the multi-posture computing device. Because this is a raw image from the image sensor, the image is configured in the full aspect ratio of the camera. In various examples, integrated cameras have a natural aspect ratio of 4:3. For reference, a typical widescreen display such as a computer monitor has a 16:9 aspect ratio.

After receiving the image from the image sensor, an angle of rotation is determined for the computing device. For instance, the operating system can poll various sensors such as an accelerometer to determine the current posture and/or angle of the computing device. In various examples, the angle of rotation is expressed relative to a default posture of the computing device. For instance, a tablet device may be configured with a default landscape posture. Consequently, a portrait posture of the tablet will be interpreted by the operating system as a ninety-degree (90°) angle of rotation.

The ISP or driver then rotates the image based on the angle of rotation of the computing device. In this way, an upper edge of the image is correctly aligned with the current upper edge of the computing device. Consequently, the resultant image appears right side up regardless of the current angle of rotation of the computing device. For example, if a user is in a video call while holding their tablet in the default landscape posture, no rotation is necessary, and the user appears right side up to other users in the video call. However, if the user changes posture and rotates the tablet ninety degrees to a portrait posture, the image is rotated in kind to maintain the right side up appearance for the user's video feed.

In addition to rotation, the image can subsequently be cropped to fit a predefined output aspect ratio. As mentioned above, many cameras have a default aspect ratio of 4:3 while many computer displays have an aspect ratio of 16:9. To suit the format of these displays, the ISP or the driver can be configured with an output aspect ratio which is then applied to images from the image sensor. In this way, the ISP or driver generates an output stream with a consistent posture and aspect ratio to streamline the user experience. The rotated and/or cropped image is then encoded to generate an output stream that is provided to an application that is utilizing the camera. As mentioned above, an example includes a video calling application that displays and/or transmits video images.

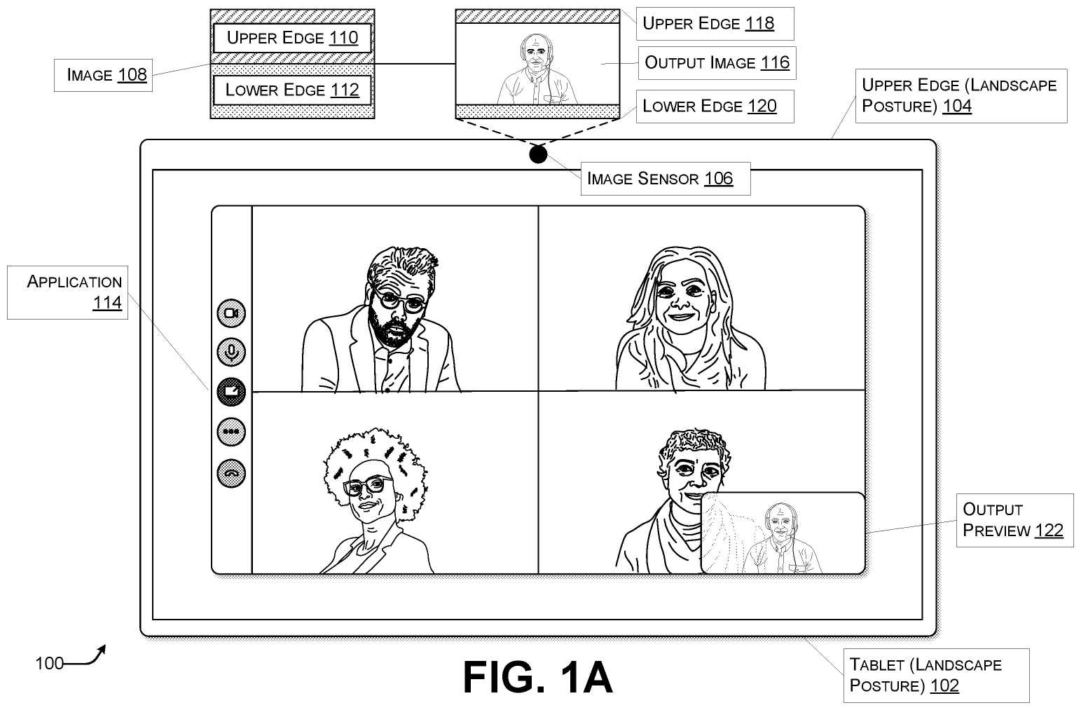

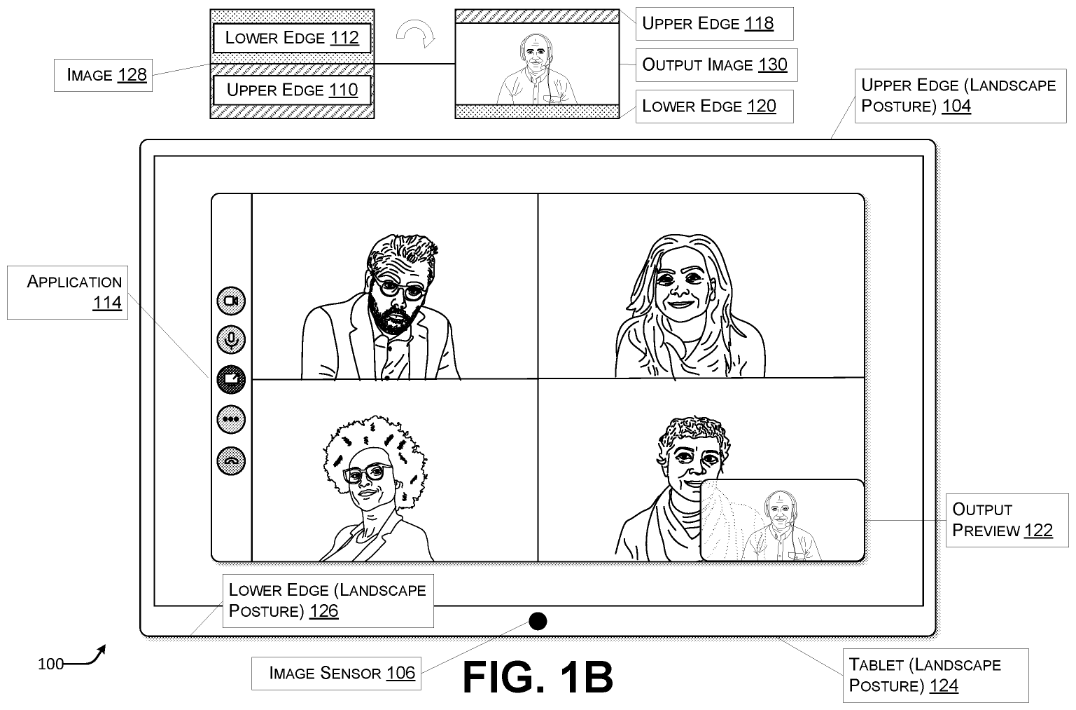

Various examples, scenarios, and aspects that enable automatic camera rotation and/or cropping on multi-posture computing devices are described below with respect to FIGS. 1A-6.

FIG. 1A illustrates an example environment 100 in which a tablet device 102 is oriented in a landscape posture. That is, the tablet device 102 is positioned such that a longer side of the tablet device 102 is an upper edge 104. In this landscape posture, an image sensor 106 that is fixed to the tablet device 102 lies on the upper edge 104. The image sensor 106 captures an image 108 which itself comprises an upper edge 110 and a lower edge 112. The upper edge 110 is shown using the diagonal shading while the lower edge 112 is shown using the dotted shading. In various examples, the landscape posture of the tablet device 102 shown in FIG. 1, in which the image sensor 106 is located at the upper edge 104, is considered a default posture as the aspect ratio of the image sensor 106 is aligned with an intended output aspect ratio. Moreover, a user often uses the landscape posture when interacting with a video call application 114.

Accordingly, no rotation needs to be applied to the image 108 to generate the output image 116 as the upper edge 110 of the image 108 already aligns with the upper edge 104 of the tablet device 102. However, as mentioned above, the image 108 received from the image sensor 106 is in a default aspect ratio (e.g., 4:3). To suit the application 114, the image 108 is cropped to a 16:9 aspect ratio to generate the output image 116. As shown in the upper middle of FIG. 1A, the upper edge 110 and lower edge 112 of the image correspond to the upper edge 118 and lower edge 120 of the output image 116 (e.g., the upper and lower edges remain unchanged). However, the output image 116 is cropped from the original image 108 as shown by the visible shading for the upper edge 118 and the lower edge 120. The output image 116 is subsequently provided to the application 114 for use in the video call. As shown in FIG. 1A, an output preview 122 comprising the output image 116 is displayed in the application concurrently with other participants of the video call to provide the user a video preview as they appear to the other users (e.g., a “Me” or a “Self” view).

Proceeding to FIG. 1B, a tablet device 124 in an alternative landscape posture is shown in which the image sensor 106 is now located on a lower edge 126 of the tablet device 124 in response to a user rotating the tablet device 180 degrees from the default posture in FIG. 1A. While still in a landscape posture, the image sensor 106 is now physically upside down. This posture is detected by the tablet device 124 and/or various operating system components of the tablet device 124 which can be used to determine an angle of rotation. In this example, the angle of rotation is one hundred and eighty degrees (180°). Furthermore, the image sensor 106, having been rotated upside down, now captures an image 128 that is different from the image 108 shown in FIG. 1A. As shown, in FIG. 1B, the upper edge 110 and the lower edge 112 of the image 128 are reversed due to the rotation of the image sensor 106. Accordingly, in addition to the cropping discussed above, the image 128 is also rotated to generate an output image 130 that appears identical to the output image 116 shown in FIG. 1A, despite the change in device posture based on the rotation. As such, the upper edge 118 of the output image 130 (after the rotation) aligns with the upper edge 104 of the tablet device 124. Intuitively, without adequately rotating the image 128, the resultant output image 130 would have appeared upside down when encoded and rendered by the application 114 at the tablet device 124.

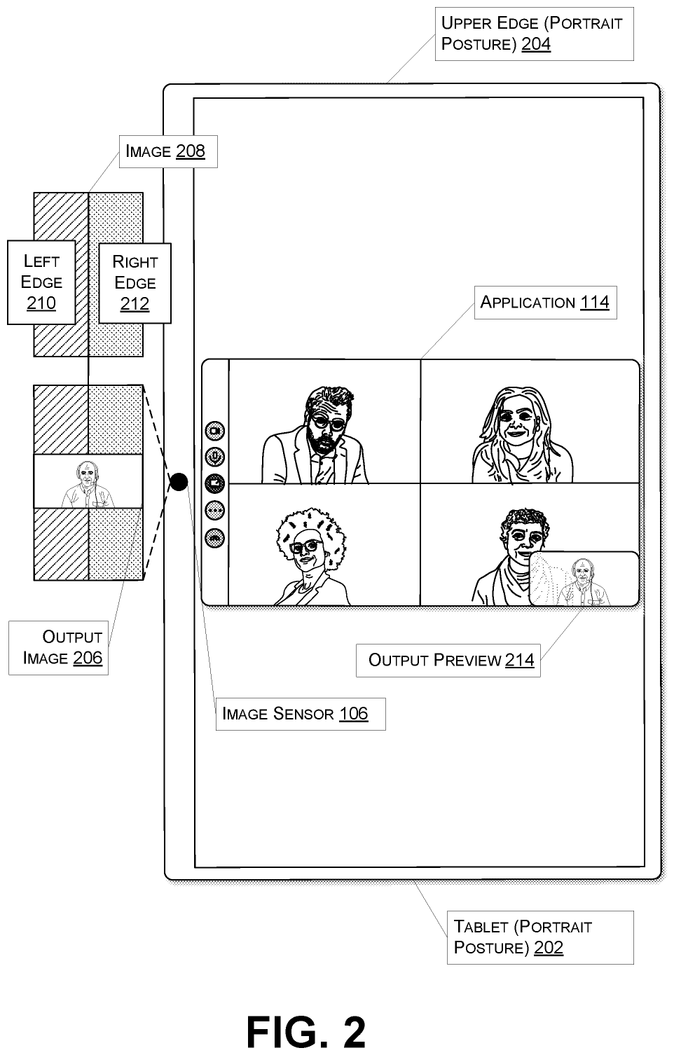

Turning now to FIG. 2, a tablet device 202 is positioned in a portrait posture rather than the different landscape postures discussed above with respect to FIGS. 1A and 1B. As shown in FIG. 2, rotating the tablet device 202 to the portrait posture changes the current upper edge 204 of the tablet device 202 to a shorter side of the tablet device 202. As such, the image sensor 106 is no longer aligned with the upper edge 204 of the tablet device 202. In addition, the video calling application 114 is also rotated to fit the altered dimensions of the screen of the tablet device 202. In contrast to the example discussed above with respect to FIG. 1A, additional processing must be carried out to ensure an output image 206 remains consistent with the output image 116 of the default landscape posture.

As discussed above, the image 108 of FIG. 1A is already right side up and thus requires no rotation to generate an output image 116 that appears right side up when rendered by the application 114. In contrast, the image 208 captured by the image sensor 106 in FIG. 2 appears sideways if left unaltered due to the changed posture of the image sensor 106. Accordingly, the upper edge 110 and the lower edge 112 from FIG. 1A are redefined in this portrait posture context as a left edge 210 and a right edge 212 respectively. As shown in FIG. 2, the left edge 210 is denoted by the diagonal line shading while the right edge 212 is denoted by the dotted shading. While the portrait posture of the tablet device 202 illustrated in FIG. 2 places the image sensor 106 on the left side of the tablet device 202, a portrait posture in which the image sensor 106 is located on the right side is also considered and handled in a similar manner.

To maintain visual consistency within the video call application 114, the image 208 is formatted such that the output image 206 and the resulting output preview 214 appear identical to the output image 116 and output preview 122 in the default landscape posture. Stated alternatively, an image 208 captured by the image sensor 106 is formatted to a predetermined posture and a predetermined aspect ratio and/or resolution to generate an output image 206. In the example of FIG. 2, the angle of rotation is determined to be two hundred and seventy degrees (270°), e.g., in a clockwise direction. Accordingly, the image 208 is rotated two hundred and seventy degrees (270°) to align the left edge 210 of the image 208 with the upper edge 204 of the tablet device 202. In this way, the image 208 appears right side up by aligning what is visually the upper edge of the image 208 (e.g., the top of the user's head) with the upper edge 204 of the tablet device 202.

In various examples, a predefined rotation posture for the image is selected using the angle of rotation and applied to the image. For instance, the angle of rotation is determined using a three-hundred-and-sixty-degree perspective that is divided into ninety-degree increments. That is, a first rotation to the right (i.e., in the clockwise direction) constitutes a ninety-degree (90°) rotation while a second rotation is a one-hundred-eighty-degree (180°) rotation, and a third rotation is a two-hundred-seventy-degree (270°) rotation. An actual angle of rotation can be associated with the closest predefined rotation posture (e.g., one of the ninety-degree increments—zero degrees (0°), ninety degrees (90°), one hundred and eighty degrees (180°), two hundred and seventy degrees (270°)). For example, if a user rotates the tablet device 202 to a one-hundred-and-five-degree (105°) angle, it is interpreted as being a predefined rotation posture of ninety degrees (90°). Accordingly, the image 208 is rotated ninety degrees (90°) resulting in an output image 206, where the user may still be slightly skewed. However, if a user rotates the tablet device 202 to a one-hundred-forty-five-degree (145°) angle, it is interpreted as being a predefined rotation posture of one hundred eighty degrees (180°). Accordingly, the image 208 is rotated one hundred and eighty degrees (180°) resulting in an output image 206, where the user may still appear slightly skewed.

In an alternative example, the angle of rotation is applied to the image precisely. For instance, if the user rotates the tablet device 202 to a forty-five-degree (45°) angle, a forty-five-degree (45°) rotation is applied to the image 208 to maintain a right-side-up appearance with no skew. In still another example, the tablet device 202 is configured such that angle of rotation is determined as a left or right rotation. For instance, rotating the tablet device 202 from a default landscape posture to the right constitutes a ninety-degree (90°) rotation. Conversely, rotating the tablet device 202 from a default landscape posture to the left constitutes a negative ninety-degree (−90°) rotation. Irrespective of how the angle of rotation is calculated, the image 208 is rotated based on the angle of rotation.

After applying the angle of rotation, the image 208 is cropped to a predetermined output aspect ratio and/or output resolution. For example, the image 208 is cropped down from the native 4:3 aspect ratio of the image sensor to a predefined output aspect ratio of 16:9. In another example, the image 208 is cropped form a native resolution of five megapixels or 2592×1944 to a predefined output resolution of 1080p or 1920×1080. The image 208 is now ready to be encoded by the tablet device 202 to generate an output image 206, e.g., for display and transmission by the video calling application 114.

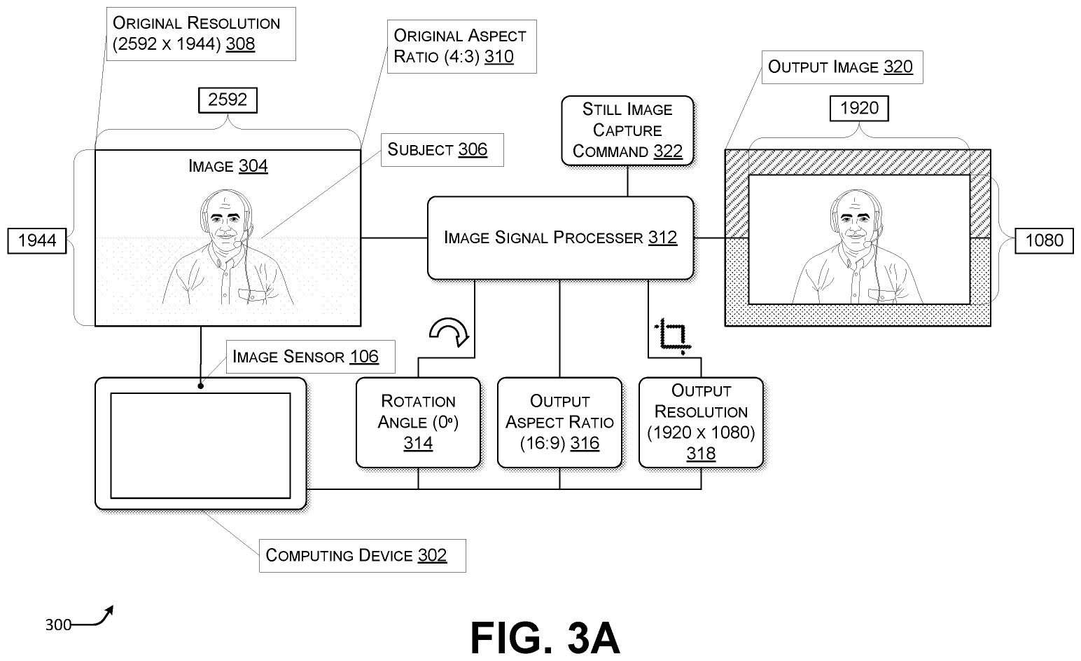

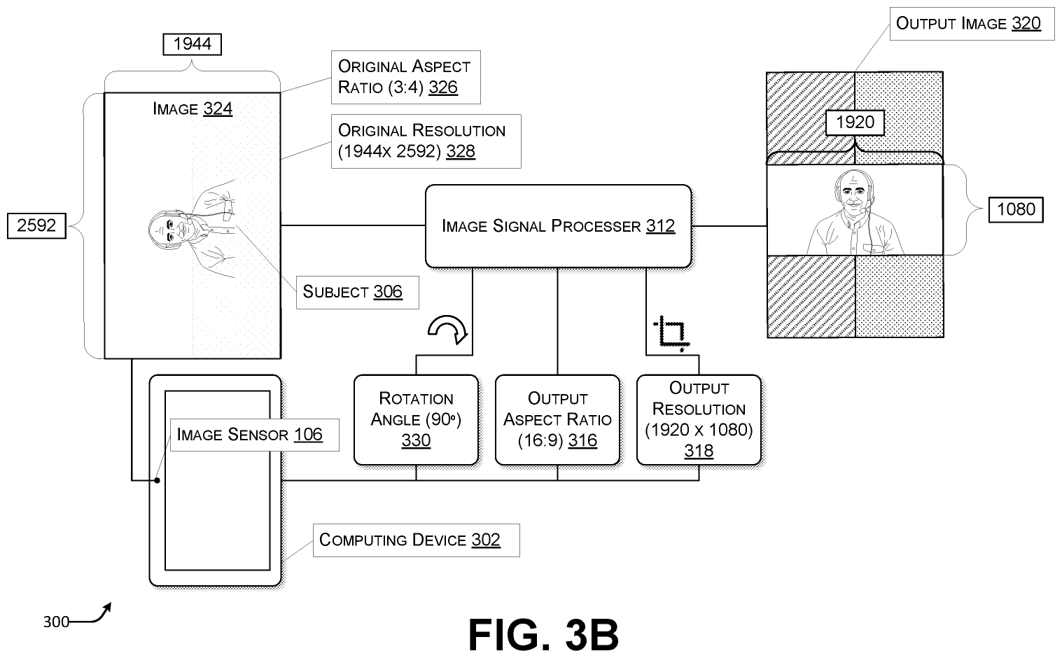

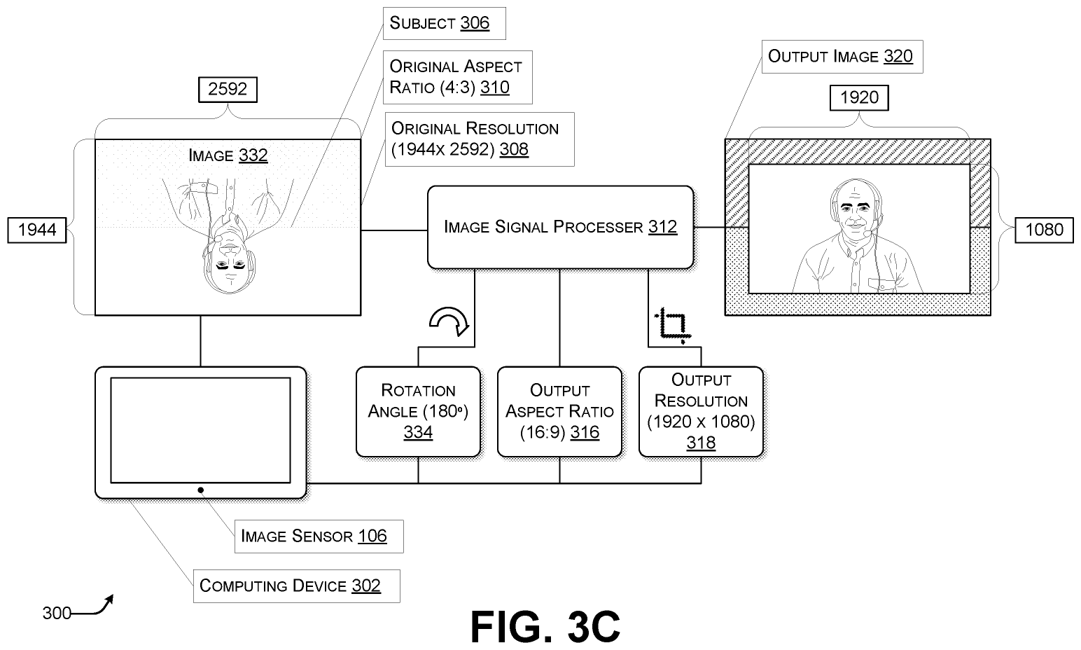

Turning now to FIG. 3A, aspects of a system 300 for enabling camera rotation and reformatting features for multi-posture devices are shown and described. As discussed above, an image sensor 106 that is fixed to a computing device 302 captures an image 304. The image 304 contains a subject 306 which is usually a person in the context of video capture (e.g., video calling, video capture, livestreaming). In addition, the image 304 is formatted in an original resolution 308 and original aspect ratio 310. As shown in FIG. 3A, the image sensor 106 is a five-megapixel device resulting in an original resolution 308 of 2592×1944 and an original aspect ratio 310 of 4:3. The image 304 is then provided to an image signal processor 312 for reformatting. In various examples, the image sensor 106 and the image signal processor 312 are components of a camera module that is fixed to the computing device 302. Moreover, the computing device 302 is any multi-posture computing device that can be freely rotated by a user such as a tablet device, a foldable device, a smartphone device, and so forth.

When the image 304 is captured, the computing device 302 proceeds to determine a rotation angle 314 defining the current posture of the computing device 302. As shown by the posture of the computing device 302, the computing device 302 is currently in the default landscape posture shown in FIG. 1A. Accordingly, the image sensor 106 is aligned with the computing device 302 resulting in a rotation angle 314 of zero degrees (0°). Consequently, the computing device 302 determines that there is no need to rotate the image 304. In various examples, the rotation angle 314 is determined by a sensor onboard the computing device 302 such as an accelerometer, a geomagnetic field sensor, and the like.

In addition, the computing device 302 is configured with an output aspect ratio 316 and/or an output resolution 318. The output aspect ratio 316 and the output resolution 318 define the expected dimensions of an output image 320. Regardless of the original resolution 308 and the original aspect ratio 310 of the image 304, the output image 320 is formatted using the output aspect ratio 316 and/or the output resolution 318. Accordingly, the image signal processor 312 crops the previously rotated image 304 from the original aspect ratio 310 to the output aspect ratio 316. Alternatively, the rotated image 304 is cropped from the original resolution 308 to the output resolution 318. Finally, to generate the output image 320, the image signal processor 312 encodes the image 304 which has been reformatted to the output aspect ratio 316 and/or the output resolution 318.

In various examples, the output aspect ratio 316 and the output resolution 318 are configured on a per application basis. Accordingly, the video calling application 114 discussed above may have a first output aspect ratio 316 and output resolution 318 while a different application defines a different output aspect ratio and output resolution. In an alternative example, the output aspect ratio 316 and the output resolution 318 are defined device-wide as part of the operating system and are thus applied regardless of the application. Moreover, the device-wide output aspect ratio 316 and the output resolution 318 can be manually adjusted on a per application basis using corresponding settings to suit user preferences.

In addition, the rotation and cropping processing of the image 304 can be suspended in response to a still image capture command 322. For example, if a user wishes to use the computing device 302 to take a picture rather than make a video call, automatically rotating and cropping the image 304 as discussed can lead to a frustrating user experience as the user receives an output image 320 that is very different from the image 304 shown in a camera viewfinder. Consequently, the rotation and cropping operations may be configured to be called upon only when desired.

Turning now to FIG. 3B, the computing device 302 is physically rotated to a portrait posture such that the image sensor 106 is not aligned with the current upper edge of the computing device 302. Consequently, an image 324 captured by the image sensor 106 is also rotated and is now formatted in a different original aspect ratio 326. Similarly, the rotation results in a different original resolution 328 for the image 324. In this example, the subject 306 is shown on its side due to the rotated posture of the computing device 302. Accordingly, the computing device 302 determines a different rotation angle 330. As shown in FIG. 3B, the rotation angle is two hundred and seventy degrees (270°). Alternatively, the rotation angle 330 can be expressed as a negative ninety degrees (−90°) to express a rotation to a portrait posture in the opposite direction.

To generate the same output image 320 as the example of FIG. 3A, the image signal processor 312 applies the rotation angle 330 to the image 324. As discussed above, the upper edge of the image 324 (as shown by the horizontal line shading) is aligned with the upper edge 204 of the computing device 302. In this way, the rotation of the computing device 302 is removed from the image 324 and ensures the subject 306 appears right side up in the output image 320. Once properly rotated, the image 324 is cropped by the image signal processor 312 to conform to the output aspect ratio 316 and/or the output resolution 318 to generate a processed image that can be encoded to generate the output image 320.

Turning to FIG. 3C, another example situation is shown in which the computing device 302 is rotated such that the image sensor 106 is placed on the current bottom edge of the computing device 302. As such, the subject 306 appears upside down when an image 332 is captured by the image sensor 106 and provided to the image signal processor 312. Since the computing device 302 is once again in a horizontal landscape posture, albeit an alternative landscape posture when compared to the default baseline posture, the original resolution 308 and the original aspect ratio 310 are the same as the image 304 shown in FIG. 3A. In addition, based on the current posture of the computing device 302, the rotation angle 334 is determined to be one hundred and eighty degrees (180°). Accordingly, the rotation angle 334 is applied to the image 332 by the image signal processer 312 so that the subject 306 appears right side up. Similar to the prior examples, the image signal processer 312 crops the rotated image to the dimensions defined by the output aspect ratio 316 and the output resolution 318. Finally, the output image 320 is generated by the image signal processer 312 by encoding the processed (i.e., rotated and/or cropped) image.

In the examples discussed herein with respect to FIGS. 3A-3C, the output aspect ratio 316 is 16:9 and the output resolution 318 is 1920×1080. By formatting content for dimensions for common widescreen displays, the system 300 creates a visually consistent and aesthetically pleasing user experience.

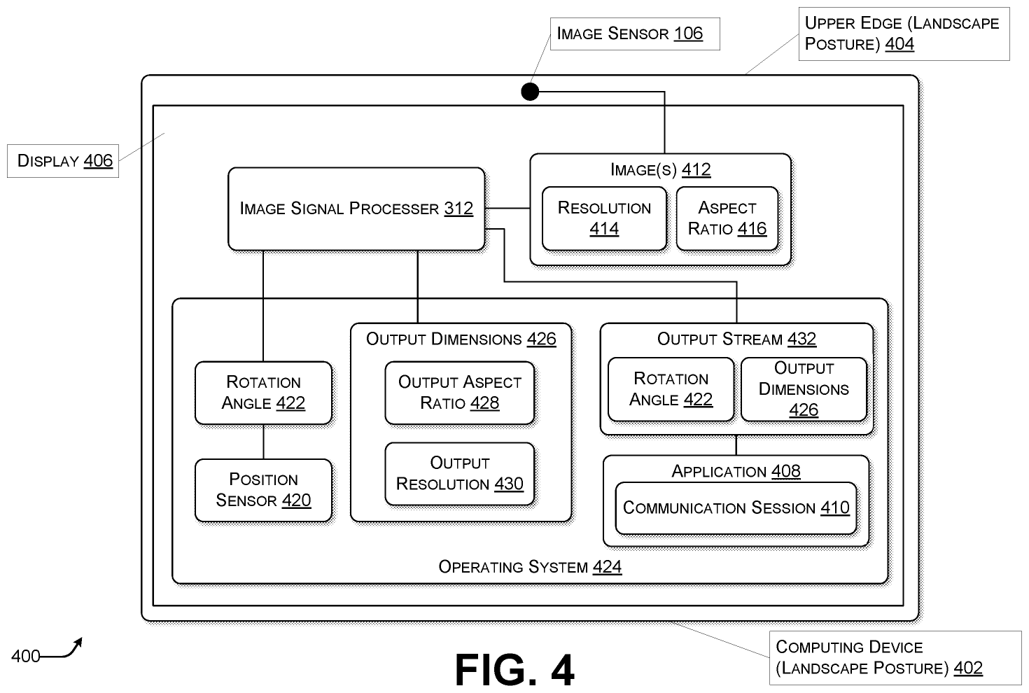

Proceeding now to FIG. 4, additional aspects of an example system 400 for enabling camera rotation and reformatting features for multi-posture devices are shown and described. In this example, a computing device 402 is oriented in a landscape posture. As such, an image sensor 106 is aligned with an upper edge 404 of the computing device 402. A user of the computing device 402 interacts with a display 406 of the computing device 402 to use an application 408 and participate in a communication session 410. For example, the communication session 410 is a video call with a plurality of other users. To participate in the communication session 410, the image sensor 106 captures image(s) 412 for transmission in the application 408. As discussed above, the image(s) 412 captured by the image sensor 106 are formatted in a first resolution 414 and aspect ratio 416. For instance, the image sensor 106 is a five-megapixel sensor which produces an image 412 with a native resolution 414 of 2592×1944 in an aspect ratio 416 of 4:3. The image 412 is then provided to an image signal processor 312 for to generate an output stream 418.

As mentioned above, by reformatting the image 412 using the image signal processer 312 (or alternatively a driver), the burden of correctly formatting the image 412 is removed from the application 408. Consequently, the image sensor 106 can be configured to appear to the operating system 424 and/or the application 408 as an external device. In this way, the system 400 simplifies the image processing demands for the application 408 by enabling the image sensor 106 to prevent the application 408 from further formatting (e.g., rotating, cropping) the image. Stated another way, by formatting the image 412 using the image signal processer 312, the application 408 merely needs to receive and display the image 412 thereby streamlining the logic of the application 408 and improving performance.

To maintain visual consistency, the image signal processer 312 is configured to align the image 412 with the upper edge 404 of the computing device 402 (e.g., upper edge 110). This is achieved by utilizing a position sensor 420 to calculate a rotation angle 422. The position sensor 420 is any hardware and/or software component that enables an operating system 424 to determine the current position of the computing device 402. In one example, the position sensor 420 includes an accelerometer, a geomagnetic field sensor, and the like. As shown and discussed above, the rotation angle 422 enables the image signal processer 312 to maintain a right side up appearance for the image 412 by rotating the image 412 based on the current rotation of the device 402.

In addition, the operating system 424 is configured with output dimensions 426 that define an output aspect ratio 428 and/or an output resolution 430 for the output stream 418. The output dimensions 426 are provided to the image signal processor 312 along with the rotation angle 422 for reformatting the image 412. Once configured, the image signal processer 312 rotates the image 412 based on the rotation angle 422. In addition, the image 412 is subsequently cropped to the output dimensions 426. After reformatting the image 412, the image signal processer 312 encodes the image 412 to generate the output stream 418. The output stream is then provided to the application 408 for rendering and/or transmission in the communication session 410. In various examples, that the output dimensions 426 are applied to the image 412 independent of the current posture of the computing device 402 as defined by the rotation angle 422. In this way, the image signal processer 312 generates an output stream 418 that is visually consistent thereby streamlining the user experience.

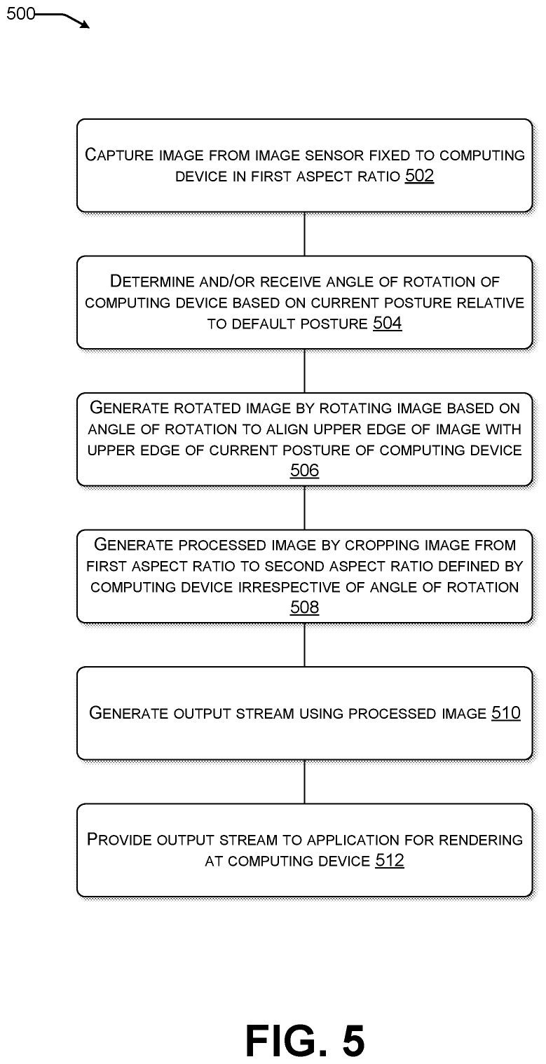

Turning now to FIG. 5, aspects of a routine 500 for enabling camera rotation for multi-posture computing devices is shown and described. With reference to FIG. 5, the routine 500 begins at operation 502, where a device and/or camera module that is fixed to a computing device captures an image that is formatted in a first aspect ratio.

Next, at operation 504, the device and/or camera module determines and/or receives an angle of rotation of the computing device based on the current posture of the device relative to a default posture of the device.

Then, at operation 506, the device and/or camera module generates a rotated image by rotating the image based on the angle of rotation such that an upper edge of the image aligns with the upper edge of the device in the current posture.

Subsequently, at operation 508, the device and/or camera module generates a processed image by cropping the image from the first aspect ratio to a second aspect ratio defined by the computing device, irrespective of the angle of rotation.

Next, at operation 510, the device generates an output stream using the processed image.

Finally, at operation 512, the output stream is provided to an application for rendering at the computing device.

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 500 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the routine 500 may be also implemented in other ways. In addition, one or more of the operations of the routine 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

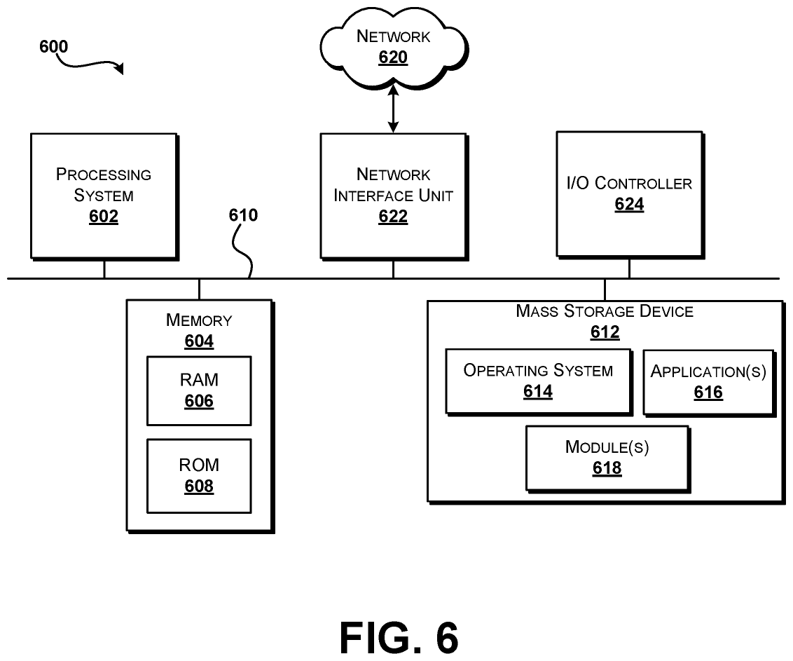

FIG. 6 shows additional details of an example computer architecture 600 for a device, such as a computer or a server configured as part of the cloud-based platform or system 100, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s). In various examples, the processing unit(s) of the processing system 602 are distributed. Stated another way, one processing unit of the processing system 602 may be located in a first location (e.g., a rack within a datacenter) while another processing unit of the processing system 602 is located in a second location separate from the first location.

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

The disclosure presented herein also encompasses the subject matter set forth in the following clauses.

Example Clause A, a method comprising: capturing, by an image sensor fixed to a computing device, an image formatted in a first aspect ratio; determining an angle of rotation of the computing device based on a current posture of the computing device and a default posture of the computing device, wherein the current posture of the computing device has an upper edge; generating a rotated image by rotating the image based on the angle of rotation of the computing device such that an upper edge of the image aligns with the upper edge of the current posture of the computing device; generating a processed image by cropping the rotated image from the first aspect ratio to a second aspect ratio defined by the computing device; generating an output stream using the processed image; and providing the output stream to an application for rendering at the computing device.

Example Clause B, the method of Example Clause A, wherein rotating the image comprises: selecting a predefined rotation posture for the image using the angle of rotation; and applying the predefined rotation posture to the image.

Example Clause C, the method of Example Clause B, wherein the predefined rotation posture comprises one of a ninety-degree rotation posture, a one-hundred-eighty-degree rotation posture, and a two-hundred-seventy-degree rotation posture.

Example Clause D, the method of any one of Example Clause A through C, wherein the angle of rotation of the computing device is determined by a position sensor of the computing device.

Example Clause E, the method of any one of Example Clause A through D, wherein the application is prevented from rotating the image.

Example Clause F, the method of any one of Example Clause A through E, wherein the application is a communications application for video conferencing.

Example Clause G, the method of any one of Example Clause A through F, wherein cropping the image further comprises: receiving a predetermined resolution for the output stream defined by the computing device; and cropping the image from the first aspect ratio to the second aspect ratio while maintaining the predetermined resolution for the output stream.

Example Clause H, a computing device, comprising: a processing system; and a computer-readable storage medium having encoded thereon computer-readable instructions that, when executed by the processing system, cause the system to: capture an image using an image sensor fixed to the computing device; determine an angle of rotation of the computing device based on a current posture of the computing device and a default posture of the computing device, wherein the current posture of the computing device has an upper edge; generating a rotated image by rotating the image based on the angle of rotation of the computing device such that an upper edge of the image aligns with the upper edge of the current posture of the computing device; generate an output stream using the rotated image; and provide the output stream to an application for rendering.

Example Clause I, the computing device of Example Clause H, wherein the image is rotated by a driver that is associated with the image sensor.

Example Clause J, the computing device of Example Clause H, wherein the image is rotated by an image signal processor that is associated with the image sensor.

Example Clause K, the computing device of any one of Example Clause H through J, wherein the angle of rotation of the computing device is determined by a position sensor of the computing device.

Example Clause L, the computing device of any one of Example Clause H through K, wherein the image sensor is configured to prevent the application from rotating the image.

Example Clause M, the computing device of any one of Example Clause H through L, wherein the rotated image is formatted in a first aspect ratio and the computer-readable instructions further cause the computing device to generate a processed image by cropping the rotated image from the first aspect ratio to a second aspect ratio defined by the computing device.

Example Clause N, the computing device of Example Clause M, wherein: the computer-readable instructions further cause the computing device to receive a predetermined resolution for the output stream defined by the computing device; and the predetermined resolution is maintained while the rotated image is cropped from the first aspect ratio to the second aspect ratio.

Example Clause O, a device, comprising: an image sensor fixed to a computing device; an image signal processor; and a computer-readable storage medium having encoded thereon computer-readable that when executed by the image signal processor, causes the device to: receive, from the image sensor, an image; receive an angle of rotation of the computing device based on a current posture of the computing device and a default posture of the computing device, wherein the current posture of the computing device has an upper edge; generate a rotated image by rotating the image based on the angle of rotation of the computing device such that an upper edge of the image aligns with the upper edge of the computing device; generate an output stream using the rotated image; and provide the output stream to an application for rendering at the computing device.

Example Clause P, the device of Example Clause O, wherein the current angle of rotation of the computing device is determined by a position sensor and received from an operating system.

Example Clause Q, the device of Example Clause O or Example Clause P, wherein rotating the image comprises: selecting a predefined rotation posture for the image using the angle of rotation; and applying the predefined rotation posture to the image.

Example Clause R, the device of Example Clause Q, wherein the predefined rotation posture comprises one of a ninety-degree rotation posture, a one-hundred-eighty-degree rotation posture, and a two-hundred-seventy-degree rotation posture.

Example Clause S, the device of any one of Example Clause O through R, wherein the rotated image is formatted in a first aspect ratio and the computer-readable instructions further cause the device to generate a processed image by cropping the rotated image from the first aspect ratio to a second aspect ratio defined by the computing device.

Example Clause T, the device of Example Clause S, wherein: the computer-readable instructions further cause the device to receive a predetermined resolution for the output stream defined by the computing device; and the predetermined resolution is maintained while the rotated image is cropped from the first aspect ratio to the second aspect ratio.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different postures).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

I/We claim:

1. A method comprising:
capturing, by an image sensor fixed to a computing device, an image formatted in a first aspect ratio;
determining an angle of rotation of the computing device based on a current posture of the computing device and a default posture of the computing device, wherein the current posture of the computing device has an upper edge;
generating a rotated image by rotating the image based on the angle of rotation of the computing device such that an upper edge of the image aligns with the upper edge of the current posture of the computing device;
generating a processed image by cropping the rotated image from the first aspect ratio to a second aspect ratio defined by the computing device;
generating an output stream using the processed image; and
providing the output stream to an application for rendering at the computing device.

2. The method of claim 1, wherein rotating the image comprises:
selecting a predefined rotation posture for the image using the angle of rotation; and
applying the predefined rotation posture to the image.

3. The method of claim 2, wherein the predefined rotation posture comprises one of a ninety-degree rotation posture, a one-hundred-eighty-degree rotation posture, and a two-hundred-seventy-degree rotation posture.

4. The method of claim 1, wherein the angle of rotation of the computing device is determined by a position sensor of the computing device.

5. The method of claim 1, wherein the application is prevented from rotating the image.

6. The method of claim 1, wherein the application is a communications application for video conferencing.

7. The method of claim 1, wherein cropping the image further comprises:
receiving a predetermined resolution for the output stream defined by the computing device; and
cropping the image from the first aspect ratio to the second aspect ratio while maintaining the predetermined resolution for the output stream.

8. A computing device, comprising:
a processing system; and
a computer-readable storage medium having encoded thereon computer-readable instructions that, when executed by the processing system, cause the system to:
capture an image using an image sensor fixed to the computing device;
determine an angle of rotation of the computing device based on a current posture of the computing device and a default posture of the computing device, wherein the current posture of the computing device has an upper edge;
generate a rotated image by rotating the image based on the angle of rotation of the computing device such that an upper edge of the image aligns with the upper edge of the current posture of the computing device;
generate an output stream using the rotated image; and
provide the output stream to an application for rendering.

9. The computing device of claim 8, wherein the image is rotated by a driver that is associated with the image sensor.

10. The computing device of claim 8, wherein the image is rotated by an image signal processor that is associated with the image sensor.

11. The computing device of claim 8, wherein the angle of rotation of the computing device is determined by a position sensor of the computing device.

12. The computing device of claim 8, wherein the application is prevented from rotating the image.

13. The computing device of claim 8, wherein the rotated image is formatted in a first aspect ratio and the computer-readable instructions further cause the computing device to generate a processed image by cropping the rotated image from the first aspect ratio to a second aspect ratio defined by the computing device.

14. The computing device of claim 13, wherein:
the computer-readable instructions further cause the computing device to receive a predetermined resolution for the output stream defined by the computing device; and
the predetermined resolution is maintained while the rotated image is cropped from the first aspect ratio to the second aspect ratio.

15. A device, comprising:
an image sensor fixed to a computing device;
an image signal processor; and
a computer-readable storage medium having encoded thereon computer-readable that when executed by the image signal processor, causes the device to:
receive, from the image sensor, an image;
receive an angle of rotation of the computing device based on a current posture of the computing device and a default posture of the computing device, wherein the current posture of the computing device has an upper edge;
generate a rotated image by rotating the image based on the angle of rotation of the computing device such that an upper edge of the image aligns with the upper edge of the computing device;
generate an output stream using the rotated image; and
provide the output stream to an application for rendering at the computing device.

16. The device of claim 15, wherein the current angle of rotation of the computing device is determined by a position sensor and is received from an operating system.

17. The device of claim 15, wherein rotating the image comprises:
selecting a predefined rotation posture for the image using the angle of rotation; and
applying the predefined rotation posture to the image.

18. The device of claim 17, wherein the predefined rotation posture comprises one of a ninety-degree rotation posture, a one-hundred-eighty-degree rotation posture, and a two-hundred-seventy-degree rotation posture.

19. The device of claim 15, wherein the rotated image is formatted in a first aspect ratio and the computer-readable instructions further cause the device to generate a processed image by cropping the rotated image from the first aspect ratio to a second aspect ratio defined by the computing device.

20. The device of claim 19, wherein:
the computer-readable instructions further cause the device to receive a predetermined resolution for the output stream defined by the computing device; and
the predetermined resolution is maintained while the rotated image is cropped from the first aspect ratio to the second aspect ratio.
